(19) United States
(12) Patent Application Publication
(10) Pub. No.: US 2007/0275278 A1
(43) Pub. Date: Nov. 29, 2007

(54) Integrated catalytic and turbine system and process for the generation of electricity

(75) Inventor: Herng-Shinn Hwang, Livingston, NJ (US)

Correspondence Address: Herng-Shinn Hwang, 62 Shrewsbury Drive, Livingston, NJ, 07039, US

(73) Assignee: Dr. Herng Shinn Hwang, Livingston, NJ (US)

(21) Appl. No.: 11/711,988

(22) Filed: Feb. 28, 2007

Related U.S. Application Data
(60) Provisional application No. 60/808,986, filed on May 27, 2006.

(51) Int. Cl. H01M 8/06

(52) U.S. Cl. 429/17; 429/19

(57) ABSTRACT

There is a provided an integrated system and process for the generation of electricity. The integrated generator comprises the steps of introducing a fuel mixture into a reaction zone, reacting said fuel mixture by adjusting the H₂O/C and O₂/C ratios in the feed fuel mixture to maintain constantly the temperature between 150-1000° C. in said reaction zone to produce a first refromate stream comprising steam and other gases, feeding said first stream from said reaction zone to a turbine, and generating electricity with said turbine and a generator.

There is a provided an Integrated System consists of several integrated generators combined in series. Additional air and/or fuel can be injected into the feed stream of each reformer. This integrated system can be used to generate additional electricity, improve overall thermal efficiency, recover the latent heats and remove pollution.

### CROSS REFERENCE INFORMATION

This application claims benefit to and priority of U.S. Provisional Application No. 60/808,986 filed May 27, 2006, herein incorporated by reference in its entirety.

### FIELD OF THE INVENTION

The present invention provides a new low cost integrated process and system for the generation of electricity from hydrocarbon (HC) and/or renewable fuels, air and water (steam) mixtures.

### BACKGROUND OF THE INVENTION

### Conventional Power Plant Boilers

Industrial power plants for generating large scale electrical power typically burn fossil fuels and/or biomass to generate large amount of heat, which is used to produce high pressure steam in a boiler. The steam is then fed into a steam turbine to generate electricity.

Such conventional means suffer from a number of drawbacks. For example, these processes consume an enormous amount of fossil fuel and produce an excessive amount of undesirable waste heats as well as greenhouse gases and/or pollutants such as carbon dioxide, nitrogen oxides, sulfur oxides etc. Furthermore, thermal inefficiency arises when the combustion heat is transferred from the shell side to the tube side of a boiler in order to heat and produce steam for the turbine.

With worldwide fossil fuel resources slowly becoming strained and the harmful effects of excess greenhouse gases and other pollutants becoming better understood, more efficient, low cost, reliable, portable and cleaner technologies for producing electricity are needed.

### Fuel Cells

Fuel cells offer much promise and potential as a more efficient and cleaner process for generating electricity. A number of different fuel cells are known in the art, including but not limited to Solid Oxide Fuel Cell (SOFC), Proton Exchange Membrane Fuel Cell (PEMFC), Phosphoric Acid Fuel Cell (PAFC), Alkaline Fuel Cell (AFC), Molten Carbon Fuel Cell (MCFC), Direct Methanol Fuel Cell, etc.

In its simplest form, fuel cells produce electricity through reactions between fuel and an oxidant brought into contact with two catalytic electrodes and an electrolyte. For example, hydrogen fuel and oxygen are reacted over electrodes to produce water (steam) and electricity by an electrochemical process. Other byproducts such as carbon dioxide may be present as well. The result is a far more thermally efficient and cleaner process for generating electricity.

However, despite the technology improvements in recent years, every fuel cell technology has limited short operating life, difficult for mass production, and still very expensive and unreliable. Therefore, the commercialization of hydrogen fuel cells for large scale applications is still under development and is expected to remain so in the near future. For example, PEMFC requires a constant and continuous supply of hydrogen to generate electricity and thus, a reliable source of hydrogen becomes a limitation in this process. Furthermore, fuel cell catalysts are sensitive to some residual hydrocarbons and/or impurities such as sulfur, calcium, magnesium etc. and thus, the hydrogen fuel also needs to be purified, a yet further limitation of this process. Another required improvement in fuel cell technology is the seamless integration of the fuel reformer and the fuel cell stack for long hour continuous and reliable operation. A sudden increase/decrease in power requirement can cause flow disturbance to the reformer and thus create unstable operation in the fuel cell stacks.

### Integrated Processes

A number of integrated processes and systems have sought to combine different technologies to further improve the efficiency of generating electricity.

For example, in U.S. Pat. No. 6,960,840 to Willis et al, herein incorporated by reference, two catalytic reactors are utilized with a turbo generator system to achieve, inter alia, better emission levels and higher efficiency. Air and natural gas are compressed and heat exchanged before the Primary Catalytic reactor. However, the main purpose of this primary catalytic reactor is to raise the inlet gas temperature, and the turbine is driven and the electricity is generated mainly by the homogeneous but not catalytic combustion reactions inside the turbine. In addition, water and/or steam are not used in the feed gas to absorb the reaction heats, and no precise control of O₂/C ratio is described in this primary catalytic reactor. As explained later in Example 1, a sudden momentary increase in O₂/C ratio of the feed mixture can cause the run away oxidation reactions over the Pt group catalysts, and produce within a few milliseconds excess reaction heats. These heats can permanently deactivate or even melt and destroy the catalysts, and thus reduce the reactor's reliability and its useful life. Also in this reference, the second Low Pressure Catalytic Reactor in this Integrated Processor is located downstream of the Turbine, its main purpose is to reduce exhaust gas emission and to recover the heats. Therefore, this secondary catalytic reactor does not directly participate in driving the turbine and in generating the electricity.

In U.S. Pat. No. 4,522,894 to Hwang, et al., herein incorporated by reference, electric power is generated from a fuel cell supplied with hydrogen fuel produced by an autothermal reforming process. In the autothermal reforming process, a mixture of #2 diesel oil, water and air is fed into a reformer comprising of two catalyst zones to yield hydrogen rich reformate for the fuel cell stack. In the first catalytic reaction zone, the hydrocarbon mixture is reacted in the presence of palladium and platinum catalyst under the feed mixture preferably containing H₂O to C ratio of 1.5 to 3.0 and an O₂ to C ratio of 0.35 to 0.55. The main purpose of this reaction zone is to promote catalytic partial oxidation reactions to convert the feed hydrocarbons into useful CO and hydrogen, and to preheat the feed mixture to a temperature between 600 and 1000° C. for the subsequent second reaction zone. But this reaction zone must avoid the complete combustion reactions of hydrocarbons, because the complete combustion reactions at high O₂/C ratio (>0.5) would produce CO₂, and this CO₂ cannot be used by most of the fuel cell stacks to generate electricity. In other words, the complete combustion reactions directly convert useful fuels into waste product. Therefore, to improve the fuel cell's thermal efficiency, the optima O₂/C ratio in the feed stream to the reformer must be kept within a narrow range, typically between 0.35 and 0.55 as shown in the said reference.

In the second catalytic reaction zone, the remaining unconverted hydrocarbons are reacted with H₂O in the presence of a steam reforming catalyst to yield more hydrogen and carbon monoxide. Since the rate of steam reforming reactions is much slower than that of the partial oxidation reactions, the H₂O/C ratio in the feed mixture has a very limited effect on the reformer's overall hydrogen production. Thus, this ratio is typically kept below 3.0 without reducing the fuel cell's overall thermal efficiency. In other words, there are almost no advantages of using H₂O/C ratio over 3.0 in the feed mixture as also demonstrated in the said reference.

In U.S. Pat. No. 6,436,363 to Hwang et al., herein incorporated by reference, hydrogen-rich fuel is generated from a hydrocarbon feed in an autothermal reactor containing a layered catalyst member. The layered catalyst member comprises at least a layer of steam reforming catalyst (e.g., platinum components) in contact with at least a layer of partial oxidation catalyst (e.g., palladium components). This patent catalyst is simply to reduce without losing efficiency the total catalyst volume used in an autothermal reformer, and also to improve the heat transfer efficiency between the partial oxidation and steam reforming catalysts. The reformer's optima operating H₂O/C and O₂/C ratios remain similar to those described previously in the U.S. Pat. No. 4,522,894.

In U.S. Pat. No. 6,365,290 to Ghezel-Ayagh, et al., herein incorporated by reference, a hybrid fuel system is provided which comprises a high temperature fuel cell combined with a non-catalytic heat engine (e.g., turbine generator). Fuel and water are first passed through the Anode in a high temperature fuel cell stack to generate electricity and the Anode's waste gas is then oxidized to recover the heats. Therefore, this integrated system is basically to improve the fuel cell's thermal efficiency by using the waste heat produced by the fuel cell stack to increase air pressure and temperature and then use this air to fire the heat engine cycle. Currently, any high pressure and high temperature fuel cell stack for electricity generation is expensive and is still in the development stage.

Therefore, there still remains a need for a simplified integrated system that can be readily employed and utilized in an affordable and wide scale application.

The present invention addresses the shortcomings of other integrated systems and provides a new low cost and reliable integrated catalytic and turbine system and process for generating electricity. The electricity can be generated from hydrocarbons and/or renewable energy fuels in an efficient, clean and readily available manner. Furthermore, during the energy transformation processes, the atmospheric CO₂ can be recycled and be converted naturally by tree, grass and plants into agriculture products, and these products can then be made into energy fuels. Thus, the net CO₂ produced from these fuels by this invention is counted as zero according to the Kyoto Protocol. In other words, the use of renewable bio-fuels for generating electricity by this invention can effectively reduce the overall greenhouse gas production.

### SUMMARY OF THE INVENTION

There is a provided an integrated generator for the generation of electricity comprising the process steps of introducing a fuel mixture into a reaction zone (i.e. reformer), reacting said fuel mixture in said reaction zone at temperatures between 150-1000° C. to produce a high temperature and pressure reformate stream comprising steam, one or more of H₂, CO, CO₂, N₂, O₂ and unconverted hydrocarbons, feeding said reformate stream from said reaction zone to a turbine and/or a turbo charger, and generating electricity with an electrical generator. The fuels mentioned here are C₁-C₁₆ hydrocarbons, C₁-C₈ alcohols, vegetable oils, bio-ethanol, bio-diesel, any fuels derived from biomass or from agriculture/industrial/animal wastes etc. The fuel mixture feeding to the New integrated generator comprises fuel, steam and an oxygen containing gas, and has an H₂O/C ratio greater than 1.0 (typically >3.0) and an O₂/C ratio greater than 0.20 (typically >0.60 if natural gas is used as fuel). The reaction zone includes a catalyst composition comprising one or more Pt group metal catalysts preferably supported on various type of ceramic monolith, metallic monolith, pellet, wire mesh, screen, foam, plate etc. To improve the catalyst's durability and increase the generator's operating life, it is necessary to optimize and control individually or simultaneously the H₂O/C and O₂/C ratios in the feed mixture so that the reactor's catalyst temperature in the reformer is constantly kept below 1200° C. (preferably <1000° C.).

There is also provided an integrated system for the generation of electricity. The system comprises one or more integrated generators in series, and each integrated generator comprises a reaction zone (i.e. reformer) for introducing and reacting a fuel mixture to produce rapidly (typically <100 milliseconds) and directly without a heat exchanger a first high temperature and pressure reformate stream, and a turbine with a generator in communication with said reaction zone to generate electricity from said first stream. The reaction zone includes a catalyst composition comprising one or more Pt group metal catalysts preferably supported on various types of ceramic monolith, metallic monolith, pellet, wire mesh, screen, foam, plate etc. The fuels mentioned here are C₁-C₁₆ hydrocarbons, C₁-C₆ alcohols, vegetable oils, bio-ethanol, bio-diesel, any fuels derived from biomass or from agriculture/industrial/animal wastes etc. To increase the generator's thermal efficiency and to recover all latent heats of H₂, CO and the unconverted hydrocarbons which are contained in the first stream reformate, one or more additional new integrated generators can be combined in series with the first one to form an integrated multi-generator system, and an additional controlled amount of air can be injected between generators to limit every reformer's temperature below 1200° C. (preferably at <1000° C.). The high temperature and pressure reformate stream produced by the subsequent generator in this integrated system can also be used to drive a turbine and/or a turbo charger to generate additional electricity.

Since the turbine and/or the turbo charger are driven by pressure, the gas composition in each reformate mixture is not an important factor in generating electricity. Therefore, contrary to the fuel cell applications where the O₂/C ratio must be limited within a very narrow range so that the reformer can produce CO and H₂ by the catalytic partial oxidation reactions, the operating conditions in this invention to generate high pressure reformate stream can be optimized in a much wider O₂/C range in a reaction zone. In other words, both the catalytic partial oxidation and the complete combustion reactions can successfully be used to generate high pressure reformate stream, and it is not necessary in this invention to limit the oxidation reactions to the catalytic partial oxidation reactions as shown in the integrated fuel cell systems.

Each fuel has it own latent heat, the total heats produced by the oxidation reactions over the Pt group catalysts will strongly depend on what type of fuel used, and the optima operating H₂O/C and O₂/C ratios will vary accordingly. Furthermore, excess air and fuel can be injected into the feed stream of the last generator in this integrated system to remove the pollutants, so that the final vent gas will be pollution free and will consist mainly of steam (water), CO₂, O₂ and N₂.

### BRIEF DESCRIPTION OF THE DRAWINGS

FIG. 1 is a schematic illustration of a two-generator system for generating electricity in accordance with an exemplary embodiment of the present invention.

FIG. 2 is a schematic illustration of a single generator for generating electricity in accordance with another exemplary embodiment of the present invention.

FIG. 3 is a schematic illustration of a single generator for generating electricity in accordance with an alternative embodiment of the present invention.

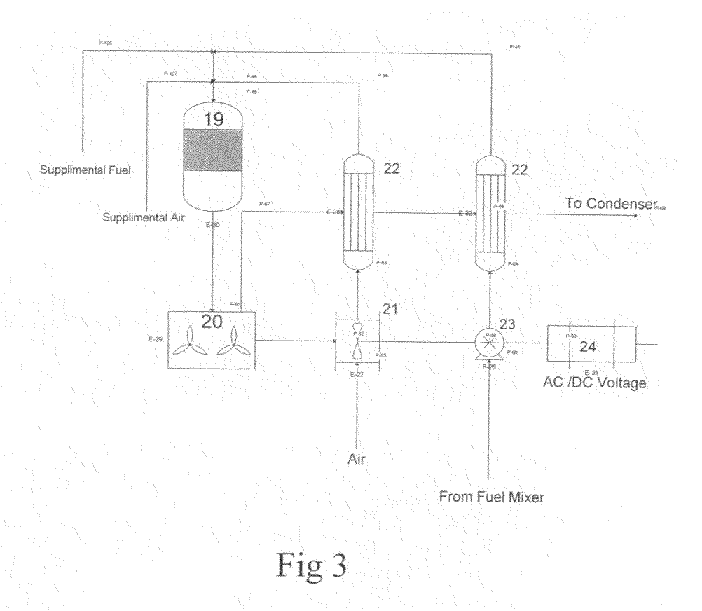

FIG. 4 is a schematic illustration of a two-generator system for generating electricity in accordance with yet another embodiment of the present invention.

### DESCRIPTION OF THE PREFERRED EMBODIMENTS

A new and novel integrated generator for generating electricity is provided. The new process comprises introducing a fuel mixture into a reaction zone, reacting the fuel mixture to produce a first stream comprising steam, feeding said first stream from said reaction zone to a turbine or a turbo charger, and generating electricity with said turbine.

A new and novel integrated system for generating electricity is also provided. The system combines several integrated generators in series and each generator comprises a reaction zone for introducing and reacting a fuel mixture to produce a reformate stream and a turbine in communication with said reaction zone for the generation of electricity from said reformate stream. To improve thermal efficiency and eliminate pollution, additional controlled amount of air and/or fuel can be injected into the feed mixture of the next reformer (i.e. reaction zone).

### Hydrocarbon Reaction Zone

In the first step of the process of the present invention, a fuel mixture is introduced into a reaction zone. The fuel mixture may comprise fuels, steam and an oxygen containing gas. The fuels may be any C₁-C₁₆ hydrocarbons, C₁-C₈ alcohols, vegetable oils, bio-ethanol, bio-diesel; any fuels derived from biomass or from agriculture/industrial/animal wastes etc. Typical useful fuels which can be oxidized by a catalytic reactor into reformate include but are not limited to natural gas, biomass waste gas, LPG, gasoline, diesel, bio-ethanol, bio-diesel, corn oil, olive oil, soybean oil, methanol, ethanol, propanol, butanol, biobutanol etc.

The oxygen containing gas may be air, oxygen or any other gaseous mixture, which contains oxygen.

The fuel, steam and oxygen containing gas may be mixed prior to feeding into the reaction zone, or may be fed separately into the reaction zone. Even if the reactants are introduced into the reaction zone separately, they become mixed in the reaction zone, and thus, this embodiment is still encompassed by the language used herein that the fuel mixture is introduced into the reaction zone.

Any conventional reactors may be used as the reaction zone. The reactor may take the form of a reformate generator or a reformer.

The reaction zone includes a catalyst composition, which can be a catalyst unsupported or supported with any known supports. If supported, the support material is preferably a substantially inert rigid material, which is capable of maintaining its shape, surface area and a sufficient degree of mechanical strength at high temperatures. Examples of viable catalyst support materials include but are not limited to alumina, alumina-silica, alumina-silica-titania, mullite, cordierite, cerium oxides, zirconium oxide, cerium-zirconium-rare earth oxide composite, zirconia-spinel, zirconia-mullite, silicon carbide and other oxide composite thereof.

The catalyst composition includes at least one metal catalyst component such as platinum, palladium, rhodium, iridium, osmium and ruthenium or mixtures thereof. Other metals may also be present, including the base metals of Group VII and metals of Groups VB, VIB and VIB of the Periodic Table of Elements (e.g., chromium, copper, vanadium, cobalt, nickel, iron, etc).

The catalyst composition in the reaction zone serves to facilitate or promote reactions between the fuel, steam and oxygen containing gas mixture. More description on the reforming of diesel oil into hydrogen by an autothermal reformer is provided in U.S. Pat. No. 4,522,894, which is hereby incorporated by reference. Multiple reactions, including steam reforming, partial oxidation, combustion, water gas shift etc. may occur simultaneously in the same reaction zone (i.e. reformer).

Because the catalysts are prone to deactivation and breakdown at high temperatures (e.g., exceeding 1200° C.), it is preferred that the reaction zone be kept at temperatures between 150-1200° C., preferably between 150-1000° C. To initiate the reaction, the fuel mixture or the reaction zone may be preheated using any known conventional means to a temperature between 150-600° C.

In the present invention, the fuel mixture is reacted over catalyst to form a first stream comprising steam (preferably >20%), one or more of H₂, CO, CO₂, N₂, CH₄, O₂ and unconverted hydrocarbons. To produce high temperature and pressure reformate stream in the first stream, two key ratios must be monitored in the fuel mixture: a) H₂O to C ratio and b) O₂ to C ratio. More specifically, it is preferred that the H₂O to C ratio be greater than 1 (preferably between 2 and 50) and the O₂ to C ratio be over 0.15 (preferably between 0.2 and 20). Since the latent heats of all useful fuels vary in a wide range and the oxidation reactions over Pt group catalysts of every fuel mentioned in this invention are very fast, these ratios should be adjusted individually and/or simultaneously depending on the specific fuel mixture composition to keep the reactions above a minimum operating temperature, and also to limit the reformer's maximum operating temperature below 1200° C. (preferably below 1000° C.). The adjustments of these two ratios to control the reaction zone temperature can be within and/or outside the operating ranges mentioned previously and are within the skills of one skilled in the art.

For example, when methane is used as the hydrocarbon fuel, the following reactions are known to occur:

Catalytic Combustion: CH₄+2O₂→CO₂+2H₂O

Catalytic Partial Oxidation Reaction: CH₄+½O₂→CO+2H₂

Steam Reforming Reaction: CH₄+H₂O→CO+3H₂

Water Gas Shift Reaction: CO+H₂O→CO₂+H₂

On the other hand, when ethanol is the fuel, the following reactions occur:

Complete Combustion: C₂H₅OH+3O₂→2CO₂+3H₂O

Catalytic Partial Oxidation: C₂H₅OH+½O₂→2CO+3H₂

Thus, different fuels result in different amounts of CO₂ and water (e.g. steam).

Different fuels also result in different amount of heat being produced. For example, while the catalytic partial oxidation reaction for methane is an exothermic reaction, the catalytic partial oxidation reaction for ethanol is an endothermic reaction.

One skilled in the art would thus appreciate that different O₂/C and H₂O/C ratios are needed for optimal operating conditions in the reaction zone (i.e. 150-1200° C.) due to the difference in oxidation reaction heats and product quantity.

### The Generation of Electricity

Once the fuel mixture is reacted to produce a first stream reformate comprising steam, and one or more of H₂, CO, CO₂, N₂, O₂ and unconverted HC, the first stream is fed into a turbine or a turbo charger to generate electricity. The turbine or turbo charger is thus said to be in communication with the reaction zone.

Turbine refers to any conventional electrical generator for which a gaseous feed (preferably high pressure gas) is used to drive the turbine to produce electricity. Turbine includes any electric generator components in communication with the actual turbine draft shaft. The most common form is a steam turbine, in which steam is used to drive the steam turbine to generate electricity.

Thus, in the exemplary embodiment of the present invention, the first stream comprising steam is fed into the turbine to generate electricity. A first stream comprising a higher percentage of steam (e.g., at least 30%, 50%, 75%) may also be used.

The first stream may be fed into the turbine via injection or any other conventional means.

### Exemplary Embodiments Described

Using the teachings of the present invention, a number of different generator and system configurations are available to one skilled in the art.

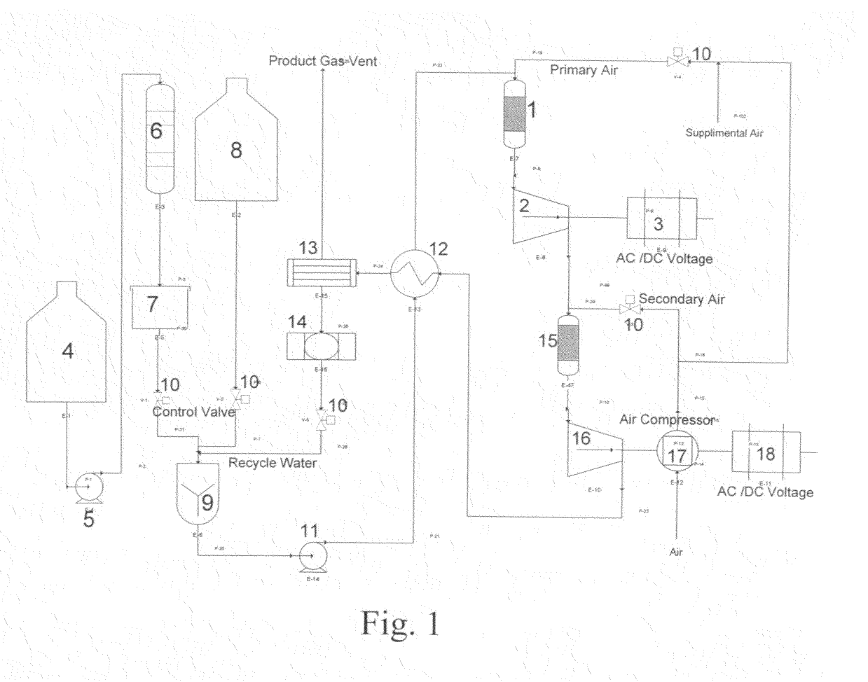

For example, as shown in an exemplary embodiment in FIG. 1, there is shown a reaction zone 1 in communication with a turbine 2, which is in further communication with an electric generator 3. Prior to feeding into reaction zone 1, there is shown a water supply 4 from which water is pumped by water pump 5 to a purifier 6. The purified water may be stored in purified water container 7. The purified water is then mixed with liquid fuel from fuel supply 8 in mixer 9 to create a fuel mixture, and fed into a heat exchanger 12 via pump 11 to preheat the hydrocarbon mixture before feeding into reaction zone 1. Various control valves 10 are situated along the paths to control the H₂O/C and O₂/C ratios as needed. However, for some fuels, it is necessary to by-pass mixer 9. They can be evaporated and heated separately, and be mixed with steam (water) after heat exchanger 12. The fuel mixture is reacted over Pt group catalysts at a very high space velocity (>15,000/hr, or residence time <240 milliseconds) in reaction zone 1, and the first stream comprising steam and other gases is fed into the turbine 2 in communication with electrical generator 3.

Since there may be H₂, CO and unreacted fuels (i.e. hydrocarbons or alcohols) present in the first stream due to insufficient oxygen in the first feed mixture, there is further shown a second reaction zone 15 in FIG. 1 to further reform or oxidize these unreacted fuels and the intermediate product gases. That is, after turbine 2, the first reformate stream is mixed with a controlled amount of secondary air to further react any unreacted hydrocarbons, H₂ and CO, and then fed into a second turbine 16 to further generate electricity. Second turbine 16 is in communication with air compressor 17 and second electric generator 18. The remaining gases exiting the second turbine 16 may be recycled to the heat exchanger 12 and may be condensed in condenser 13 to remove any undesirable by-products before being released to the atmosphere.

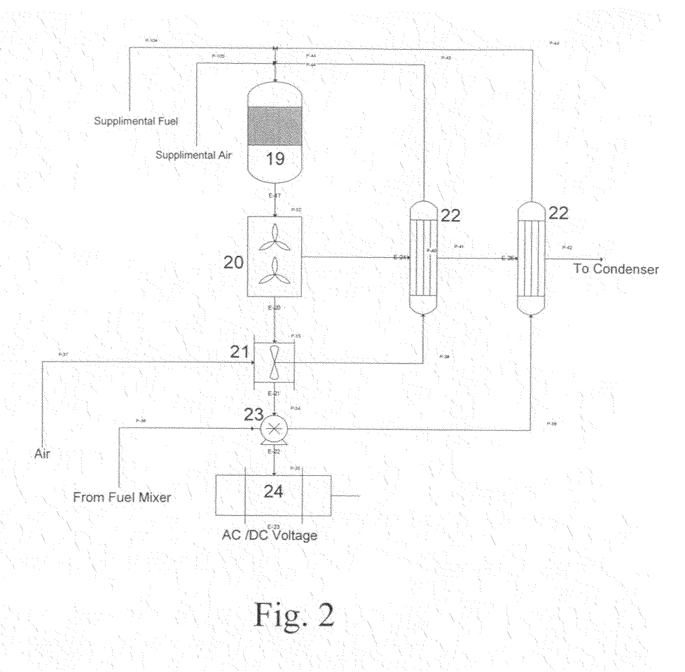

In FIG. 2, there is shown another alternative embodiment of the generator of the present invention. In FIG. 2, the air and fuel mixture (i.e. water and hydrocarbon fuel) is fed separately into the reaction zone 19. That is, air compressor 21 is used to pump air through its own heat exchanger 22 and fuel pump 23 is used to pump fuel/water mixture through its own heat exchanger 22 as well. If the fuel mixer is originally in a liquid state, then the heat exchanger 22 is used to vaporize the fuel mixture to a gaseous state before injecting into the reaction zone 19. The two components are fed separately into reaction zone 19 to produce a first stream comprising steam, which is then fed into turbine 20 in communication with electrical generator 24 to generate electricity.

The following examples are based on thermodynamic calculations using the HSC Chemistry Version 4.1 software (Outokumpu Research Oy, Pori, Finland). For example, the equilibrium gas composition for a given fuel feed mixture is first calculated at temperatures between 100 and 2500° C. The calculated equilibrium composition at a given temperature is then used to calculate the adiabatic temperature raise from the initial gas temperature at 100° C. However, it is found that, over a certain temperature range, the equilibrium composition is a strong function of temperature, i.e. a small change in temperature will cause a large change in equilibrium composition and thus affect the calculated adiabatic temperature (Tad). Therefore, the equilibrium composition at a given temperature and the calculated adiabatic temperature (Tad) for this composition should be iterated continuously until these two temperatures are finally matched. However, to demonstrate the effects of H₂O/C and O₂/C ratios on the reactor's operating temperature, and the importance of controlling these two ratios, satisfactory conclusions can be reached by using the approximate calculated values (+/−50° C.) as shown in the following tables.

### EXAMPLE 1

100 moles of various hydrocarbon mixtures comprising various amounts of methane and air are fed and reacted in the reaction zone. No water is used in this example. The calculated results from the Chemistry Version 4.1 software are summarized in Table 1.

TABLE 1
Equilibrium Gas Composition and Adiabatic Temperatures (Tad, degree C.) for
CH₄ - Air Systems

| | | | | Equilibrium Gas Composition (moles) | | | | | | | |
|---|---|---|---|---|---|---|---|---|---|---|---|
| % CH4 | H20/C | O2/C | Tad | N2 | H2O | H2 | CO | CO2 | CH4 | O2 | C |
| 4.76 | 0.00 | 4.20 | 1200.00 | 75.20 | 9.52 | 0.00 | 0.00 | 4.76 | 0.00 | 10.50 | 0.00 |
| 9.09 | 0.00 | 2.10 | 1980.00 | 71.80 | 17.90 | 0.25 | 0.64 | 8.45 | 0.00 | 1.35 | 0.00 |
| 16.67 | 0.00 | 1.05 | 1400.00 | 65.80 | 15.00 | 18.30 | 13.39 | 3.29 | 0.00 | 0.00 | 0.00 |
| 20.00 | 0.00 | 0.84 | 1110.00 | 63.20 | 10.60 | 29.40 | 17.00 | 2.96 | 0.00 | 0.00 | 0.00 |
| 28.57 | 0.00 | 0.53 | 690.00 | 56.40 | 4.96 | 47.20 | 18.60 | 3.23 | 3.51 | 0.02 | 4.25 |
| 33.30 | 0.00 | 0.42 | 657.00 | 52.70 | 7.14 | 50.80 | 13.50 | 3.67 | 4.34 | 0.01 | 11.80 |
| 41.18 | 0.00 | 0.30 | 605.00 | 46.50 | 10.80 | 52.80 | 6.84 | 3.54 | 9.39 | 0.00 | 21.40 |

This table lists the adiabatic temperature (Tad) as a function of % CH₄ (dry), and the product gas composition as a function of O₂/C ratio. For O₂/C ratios of 4.20 and 2.10, complete combustion reactions can be expected thermodynamically since all CH₄ are converted to CO₂, and the adiabatic temperatures after combustion are 12000 and 1980° C. respectively. As the O₂/C ratios is shifted toward the lower values, more H₂ and CO and less amount of CO₂ are produced, indicating that the reaction mechanism is gradually shifting from the complete combustion reactions toward the partial oxidation reactions, and the calculated adiabatic temperatures are also gradually reduced to <1000° C. Therefore, it would have been preferred to keep the O₂/C ratio below 0.84 for this methane/air system to avoid catalysts being thermally deactivated and/or melted.

As shown in Example 1, a sudden momentary increase in O₂/C ratio to a value over 1.05 can cause the catalyst's temperature over 14000° C., this will cause permanent damage and/or even melt the catalyst. Furthermore, low O₂/C ratios will produce coke (i.e. C). Thus, Example 1 confirms that U.S. Pat. No. 6,960,840, which utilized methane combustion without water in the feed gas, is susceptible to thermal deactivation, coking and/or melting of its catalysts if the O₂/C ratio is not controlled properly.

### EXAMPLE 2

Example 1 is repeated, except 100 moles of water are added to the same 100 moles of CH₄ and air mixture. The calculated adiabatic temperature raise (Tad, degree C.) and the gas composition are summarized in Table 2.

By comparing Tables 1 and 2, under the exact CH₄/air mixture, the addition of water will reduce the adiabatic temperature and avoid coke formation. Thus, Table 2 confirms that

TABLE 2
Equilibrium Gas Composition and Adiabatic Temperature (Tad, degree C.)
for CH₄ - Air-Water (100 Kmoles) systems

| | | | | Equilibrium Gas Composition (moles) | | | | | | | |
|---|---|---|---|---|---|---|---|---|---|---|---|
| % CH4 | H20/C | O2/C | Tad | N2 | H2O | H2 | CO | CO2 | CH4 | O2 | C |
| 4.76 | 21.01 | 4.20 | 650.00 | 75.20 | 110.00 | 0.00 | 0.00 | 4.76 | 0.00 | 10.50 | 0.00 |
| 9.09 | 11.00 | 2.10 | 1080.00 | 71.80 | 118.00 | 0.00 | 0.00 | 9.09 | 0.00 | 0.91 | 0.00 |
| 16.67 | 6.00 | 1.05 | 820.00 | 65.80 | 105.00 | 28.10 | 3.54 | 13.10 | 0.00 | 0.00 | 0.00 |
| 20.00 | 5.00 | 0.84 | 700.00 | 63.20 | 97.90 | 42.10 | 4.28 | 15.71 | 0.01 | 0.00 | 0.00 |
| 28.57 | 3.50 | 0.53 | 520.00 | 56.40 | 87.40 | 58.20 | 3.04 | 19.80 | 5.76 | 0.00 | 0.00 |

the use of steam in the feed gas is a useful improvement over Example 1. It is believed that steam, which has a higher heat capacity compared to other gases, absorbs reaction heats more efficiently to keep all adiabatic temperature below 1200° C. Furthermore, the addition of water to the feed mixture will shift the equilibrium composition, avoid coke formation and will favor easier and more flexible reformer operations. Thus, the catalyst life can be extended with the use of steam in the feed.

### EXAMPLE 3

Example 1 is repeated except that 200 moles of water are added to the same 100 moles of CH₄ and air mixture. The calculated adiabatic temperature (Tad, degree C.) and the gas composition are summarized in Table 3.

TABLE 3
Equilibrium Gas Composition and Adiabatic Temperature (Tad, degree C.)
for CH₄ - Air-Water (200 Kmols) Systems

| | | | | Equilibrium Gas Composition (moles) | | | | | | | |
|---|---|---|---|---|---|---|---|---|---|---|---|
| % CH4 | H20/C | O2/C | Tad | N2 | H2O | H2 | CO | CO2 | CH4 | O2 | C |
| 4.76 | 42.02 | 4.20 | 470.00 | 75.20 | 210.00 | 0.00 | 0.00 | 4.76 | 0.00 | 10.50 | 0.00 |
| 9.09 | 22.00 | 2.10 | 770.00 | 71.80 | 218.00 | 0.00 | 0.00 | 9.09 | 0.00 | 0.91 | 0.00 |
| 16.67 | 12.00 | 1.05 | 600.00 | 65.80 | 203.00 | 30.80 | 0.92 | 15.80 | 0.03 | 0.00 | 0.00 |
| 20.00 | 10.00 | 0.84 | 525.00 | 63.20 | 195.00 | 44.70 | 1.03 | 18.80 | 0.16 | 0.00 | 0.00 |
| 28.57 | 7.00 | 0.53 | 440.00 | 56.40 | 190.00 | 50.90 | 0.65 | 19.70 | 8.18 | 0.00 | 0.00 |

Compared to Example 2, Table 3 shows that an additional 100 moles of water further reduces the adiabatic temperature in the reaction zone. Table 3 illustrate that in some cases (i.e. low O₂/C ratios), the reactor temperatures are too low, indicating that catalysts may lost their activities due to low operating temperatures and may have problems of producing high-pressure reformate. Thus, Table 3 confirms the importance of maintaining control and optimizing the O₂/C and H₂O/C ratios of the feed gas.

### EXAMPLE 4

Example 1 is repeated except that ethanol was used as the fuel source instead of methane. The results of these thermodynamic calculations are shown in Table 4.

As shown in Table 4, the adiabatic temperatures for the O₂/C ratios between 2.10 and 0.70 rose over 1400° C. and, thus, the catalysts will melt and/or become thermally deactivated. Even for the O₂/C ratio of 0.26, there is a risk of catalyst deactivation as a result of carbon formation, which will block the catalyst bed and cause flow disturbance. Therefore, like Example 1 with methane, Table 4 confirms that the use of ethanol and air without water/steam in the feed mixture does not lead to a thermally efficient or successful long operation for a catalytic reformer.

TABLE 4
Equilibrium Gas Composition and Adiabatic Temperature (Tad, degree C.)
for Ethanol - Air Systems

| | | | | Equilibrium Gas Composition (moles) | | | | | | | | |
|---|---|---|---|---|---|---|---|---|---|---|---|---|
| % C2H5OH | H2O/C | O2/C | Tad (C) | N2 | H2O | H2 | CO | CO2 | CH4 | O2 | C2H5OH | C |
| 2.44 | 0 | 4.2 | 985.9 | 77.1 | 7.32 | 0 | 0 | 4.88 | 0 | 13.2 | 0 | 0 |
| 4.76 | 0 | 2.1 | 1650 | 75.2 | 14.3 | 0 | 0.03 | 9.49 | 0 | 5.75 | 0 | 0 |
| 6.54 | 0 | 1.5 | 1760 | 73.8 | 16.9 | 0.038 | 0.121 | 11.2 | 0 | 2.79 | 0.901 | 0 |
| 9.09 | 0 | 1.05 | 1730 | 71.8 | 18.4 | 0.064 | 0.196 | 12.1 | 0 | 0.765 | 2.94 | 0 |
| 13.04 | 0 | 0.7 | 1460 | 68.7 | 18.8 | 1.01 | 2.14 | 11.1 | 0 | 0 | 6.43 | 0 |
| 16.67 | 0 | 0.52 | 880 | 65.8 | 11.7 | 38.3 | 26.7 | 6.66 | 0.06 | 0 | 0.06 | 0 |
| 20 | 0 | 0.42 | 685 | 63.2 | 7.71 | 47.9 | 29.7 | 8.09 | 2.19 | 0 | 0 | 0 |
| 28.5 | 0 | 0.26 | 630 | 56.4 | 15.6 | 57.7 | 19.5 | 11.7 | 6.22 | 0 | 0 | 19.7 |

### EXAMPLE 5

Example 4 is repeated, except 100 moles of water are added to 100 moles of ethanol and air mixture. The results of the thermodynamic calculations are shown in Table 5.

TABLE 5
Equilibrium Gas Composition and Adiabatic Temperature (Tad, degree C.)
for Ethanol - Air-Water (100 Kmole) Systems

| | | | | Equilibrium Gas Composition (moles) | | | | | | | | |
|---|---|---|---|---|---|---|---|---|---|---|---|---|
| % C2H5OH | H2O/C | O2/C | Tad (C) | N2 | H2O | H2 | CO | CO2 | CH4 | O2 | C2H5OH | C |
| 2.44 | 20.49 | 4.2 | 539.7 | 77.1 | 107 | 0 | 0 | 4.88 | 0 | 13.2 | 0 | 0 |
| 4.76 | 10.5 | 2.1 | 886.1 | 75.2 | 114 | 0 | 0 | 9.52 | 0 | 5.72 | 0 | 0 |
| 6.54 | 7.65 | 1.5 | 1140 | 73.8 | 120 | 0.008 | 0.002 | 13.1 | 0 | 0.012 | 0 | 0 |
| 9.09 | 5.5 | 1.05 | 1000 | 71.8 | 114 | 13.4 | 3 | 15.2 | 0 | 0 | 0 | 0 |
| 13.04 | 3.83 | 0.7 | 800 | 68.7 | 104 | 35.4 | 6.34 | 19.7 | 0 | 0 | 0 | 0 |
| 16.67 | 3 | 0.52 | 635 | 65.8 | 92.7 | 57.1 | 7.37 | 25.8 | 0.147 | 0 | 0 | 0 |
| 20 | 2.5 | 0.42 | 560 | 63.2 | 86.9 | 66.8 | 6.92 | 29.9 | 3.18 | 0 | 0 | 0 |
| 28.57 | 1.75 | 0.26 | 510 | 56.4 | 85.2 | 65.1 | 5.56 | 33.9 | 17.7 | 0 | 0 | 0 |

Table 5 shows that, with the addition of steam, the adiabatic temperatures under various O₂/C ratios remain below 1150° C. and there is no carbon formation, thereby indicating more favorable operating conditions for the catalysts in the reaction zone. Furthermore, because of the difference in latent heat, the results of Tables 2 and 5 indicate that the optima O₂/C ratio to limit the reactor's temperature <1000° C. varies with the fuels used.

For example, Table 5 shows that for a feed mixture containing 13.04 moles of ethanol, 18.26 moles of O₂, 68.70 moles of N₂ and 100 moles of water (H₂O/C=3.83, O₂/C=0.70), the feed ethanol over the Pt group catalysts is converted completely, and the first stream will contain 68.7 moles of N₂, 104.0 moles of steam, 35.40 moles of H₂, 6.34 moles of CO and 19.7 moles of CO₂.

### EXAMPLE 6

Example 4 is repeated, except 200 moles of water are added to 100 moles of ethanol and air mixture. The results of the thermodynamic calculations are shown in Table 6.

TABLE 6
Equilibrium Gas Composition and Adiabatic Temperature for
Ethanol - Air-Water (200 Kmole) Systems

| | | | | Equilibrium Gas Composition (moles) | | | | | | | | |
|---|---|---|---|---|---|---|---|---|---|---|---|---|
| % C2H5OH | H2O/C | O2/C | Tad (C) | N2 | H2O | H2 | CO | CO2 | CH4 | O2 | C2H5OH | C |
| 2.44 | 40.98 | 4.2 | 394.6 | 77.1 | 207.3 | 0 | 0 | 4.88 | 0 | 13.2 | 0 | 0 |
| 4.76 | 21.01 | 2.1 | 642.4 | 75.2 | 214.3 | 0 | 0 | 9.52 | 0 | 5.72 | 0 | 0 |
| 6.54 | 15.29 | 1.5 | 816.4 | 73.8 | 219.6 | 0 | 0 | 13.1 | 0 | 0.1 | 0 | 0 |
| 9.09 | 11 | 1.05 | 735 | 71.8 | 212 | 15.4 | 0.924 | 17.3 | 0 | 0 | 0 | 0 |
| 13.04 | 7.67 | 0.7 | 600 | 68.7 | 199 | 39.8 | 1.85 | 24.2 | 0.011 | 0 | 0 | 0 |
| 16.67 | 6 | 0.52 | 510 | 65.8 | 189 | 58.3 | 1.9 | 30.2 | 1.19 | 0 | 0 | 0 |
| 28.57 | 3.5 | 0.26 | 445 | 56.4 | 186 | 60.1 | 1.48 | 35.7 | 20 | 0 | 0 | 0 |

Like Example 3, Table 6 again confirms the reduction of operating temperatures and catalytic activities when excess H₂O is added. Again, the optima operating H₂O/C and O₂/C ratios to limit the reactor's temperature <1000° C. vary with the type of fuels used.

### EXAMPLE 7

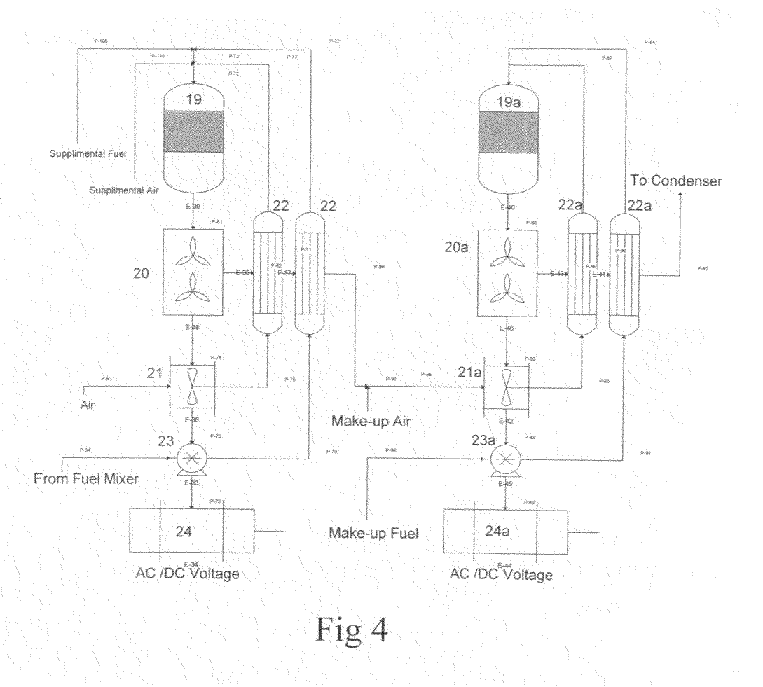

Example 7 illustrates the use of a new integrated two-generator system as shown in FIG. 4.

As shown in Table 2, a gas mixture containing 16.67 moles CH₄, 17.5 moles O₂, 65.83 moles of N₂ and 100 moles of water (H₂O/C=6.0 and O₂/C=1.05) are injected into the first new integrated generator 19 as shown in FIG. 4. Methane is oxidized in the reformer over a monolithic Pt group catalyst and the equilibrium reformate stream contains 65.80 moles N₂, 105 moles steam, 28.1 moles H₂, 3.54 moles CO and 13.1 moles CO₂. The adiabatic temperature of this high-pressure reformate is 820° C.

After driving the Turbine 20, the reformate gas will lose its pressure and temperature. Since the vent reformate gas from Turbine 20 still contains H₂ and CO, additional make-up air in the amount of 15.83 moles is added into this gas stream and the mixture is injected into the Second integrated generator 19a to recover the latent heats as shown in FIG. 4. Again, the combustion of H₂ and CO can provide reaction heats to increase the reformer temperature and produce high-pressure reformate. The adiabatic temperature is approximately at 1018.4° C. This high-pressure reformate produced in the Second Integrated Generator 19a is used to drive the Second Turbine 20a and generate additional electricity. The vent gas from Second Integrated Generator 19a contains mostly N₂, O₂, CO₂ and water, and thus can be emitted into atmosphere.

If the second integrated generator 19a cannot completely combust the intermediate products such as H₂ and CO and unconverted fuels or HC, a third integrated generator (not shown) can be added in series. In this case, additional controlled amount of air can be injected into the inlet feed mixture of this third integrated Generator. Again, the oxidation reactions can recover all latent heats to improve the system's overall thermal efficiency. Furthermore, to make sure that the final vent gas is pollution free, excess amount of air can be added into the feed stream of the last generator of the integrated system to combust all H₂, CO and HC. If necessary, a controlled amount of fuel can also be injected into the feed stream to keep the reaction zone's temperature above its minimum operating temperature and, thus, maintain the catalyst's activity and the oxidation reaction rates.

I claim:

1. An integrated generator for the generation of electricity comprising the process steps of
a) introducing a fuel mixture into a first reaction zone,
i). said fuel mixture comprising hydrocarbons (or bio-fuels), steam and an oxygen containing gas, and said fuel mixture having an H₂O/C ratio between 2.0 and 50, and an O₂/C ratio between 0.2 and 20,
ii) said first reaction zone including a catalyst composition comprising one or more supported or unsupported Pt group metal catalyst,
b) reacting said fuel mixture in said first reaction zone at temperatures between 150-1000° C. to produce a first stream comprising steam and one or more of H₂, CO, CO₂, N₂, O₂ and unconverted hydrocarbons,
c) feeding said first stream from said first reaction zone to a first turbine, said first turbine including an electrical generator and,
d) generating electricity with said first turbine and an electrical generator.

2. The process of claim 1, adjust individually and/or simultaneously the H₂O/C and O₂/C ratios to obtain the optima operating condition for a given fuel, and to control the maximum reactor temperature below 1200° C. (preferably <1000° C.).

3. The process of claim 1, wherein said catalyst composition comprises one or more of platinum, palladium, rhodium, iridium, osmium and ruthenium, and said catalyst composition is either unsupported or supported on a ceramic monolith, metallic monolith, pellet, wire mesh, screen, foam or plate.

4. The process of claim 1, wherein said catalyst composition also comprises one or more elements and/or oxides such as copper, vanadium, cerium oxide, zirconium oxide, cerium-zirconium-rare earth oxide composite, cobalt, nickel and iron.

5. The process of claim 1, wherein said fuel is a C₁-C₁₆ hydrocarbon, C₁-C₈ alcohols, vegetable oils, soybean oil, corn oil, olive oil, bio-ethanol, bio-diesel, biobutanol, methane or bio-fuels derived from biomass or from agriculture/industrial/animal wastes.

6. The process of claim 1, wherein said the inlet fuel stream of the reaction zone contains steam/water (preferably at least 20%).

7. An integrated system for the generation of electricity comprising several integrated generators in series, and the first generator comprising
a first reaction zone for introducing and reacting a fuel mixture to produce a first stream, said first reaction zone including a catalyst composition comprising one or more Pt group metal catalyst; and
a first turbine in communication with said first reaction zone for the generation of electricity from said first stream, said first turbine including an electrical generator.

8. The system of claim 7, wherein said the supported or unsupported catalyst composition comprises one or more of platinum, palladium, rhodium, iridium, osmium and ruthenium or mixtures thereof, and the catalyst can be supported on a ceramic monolith, metallic monolith, pellet, wire mesh, screen, foam, or plate.

9. The system of claim 7, wherein said the supported or unsupported catalyst also comprises one or more elements and/or oxides such as copper, vanadium, cerium oxide, zirconium oxide, cerium-zirconium-rare earth oxide composite, cobalt, nickel and iron.

10. The system of claim 7, further comprising Reacting said fuel mixture containing proper H₂O/C and O₂/C ratios in said each reaction zone in the integrated system at a temperatures between 150-1000° C. to produce a reformate stream comprising steam and one or more of H₂, CO, CO₂, N₂, O₂ and unconverted hydrocarbons.

11. The process of claim 7, wherein said fuel is a C₁-C₁₆ hydrocarbon, C₁-C₈ alcohols, vegetable oils, soybean oil, corn oil, olive oil, bio-ethanol, bio-diesel, biobutanol, methane or bio-fuels derived from biomass or from agriculture/industrial/animal wastes.

12. The system of claim 7, further comprising
a second reaction zone in communication with said first turbine,
a). said second reaction zone being for introducing and reacting a fuel mixture with additional controlled amount of air and/or fuel to produce a second stream,
b). said second reaction zone including a catalyst composition comprising one or more Pt group metal and,
a second turbine in communication with said second reaction zone for the generation of electricity from said second stream, said second turbine including an electrical generator.

13. The system of claim 7, further comprising
a). one or more additional integrated generator(s) in serial combination with the first and second integrated generators,
b). additional controlled amount of air and/or fuel are injected between two subsequent generators to keep each reaction zone temperature between 150 and 1200° C.,
c). additional electricity can be generated by every generator in this integrated system.

14. The system of claim 7 further comprising
adding the controlled amount of air and fuel into the inlet stream of the last generator in the integrated system to obtain O₂/C ratio>0.8, keep the reaction zone temperature between 150 and 1200° C., oxidize with excess O₂ all unconverted fuels including the intermediate products such as CO, CH₄ and H₂ and vent the system's exhaust gas containing only O₂, N₂, SO₂, CO₂, steam (water) and trace of other gases (i.e. <1,000 PPM).
